(19) United States
(12) Patent Application Publication
(10) Pub. No.: US 2017/0354564 A1
(43) Pub. Date: Dec. 14, 2017

(54) MOBILE WALKER, MONITORING AND INFORMATION SYSTEM WITH A MOBILE WALKER AND METHOD FOR OPERATING A MOBILE WALKER

(71) Applicant: SIEMENS HEALTHCARE GMBH, Erlangen (DE)

(72) Inventors: FRANZ DIRAUF, EBENSFELD (DE); ROBERT KAGERMEIER, NUERNBERG (DE); VERENA SCHMIDT, ERBENDORF (DE)

(21) Appl. No.: 15/618,267

(22) Filed: Jun. 9, 2017

(30) Foreign Application Priority Data
Jun. 9, 2016 (DE) 102016210212.5

(51) Int. Cl. A61H 3/04; G08B 25/01; H04W 84/12

(52) U.S. Cl. CPC A61H 3/04; G08B 25/016; H04W 84/12; A61H 2003/046

(57) ABSTRACT

A mobile walker has a frame, at least two wheels which are embodied and arranged on the frame to move the mobile walker around on a ground surface, at least one hand grip embodied and arranged on the frame to be used by a user of the mobile walker as a support and pushing aid, at least one measured value recording unit embodied and programmed to record at least one vital parameter of the user, and a processor unit which is connected communicatively to the measured value recording unit and which is embodied and programmed to assess the recorded vital parameter and/or transmit the same to a control center arranged separately from the mobile walker.

### CROSS-REFERENCE TO RELATED APPLICATION

This application claims the priority, under 35 U.S.C. §119, of German application DE 10 2016 210 212.5, filed Jun. 9, 2016; the prior application is herewith incorporated by reference in its entirety.

### BACKGROUND OF THE INVENTION

### Field of the Invention

The invention relates to a mobile walker, in particular a walking frame, having a frame, at least three wheels and hand grips for people with mobility impairments to move around. Furthermore, the invention relates to a monitoring and information system with a mobile walker of this type, and to a method for operating a mobile walker of this type.

Mobile walkers, in particular walking frames, also known as Zimmer frames, generally have a frame with four wheels for moving around on outdoor or indoor ground surfaces as well as two hand grips for a person to lean against and for the person to push and maneuver the walker. Mobile walkers are above all used by people with a permanent or temporary physical disability to move around. Mobile walkers can however likewise be used as support when standing or in special embodiments when sitting. The majority of mobile walkers also have brakes on one or a number of wheels as well as lockable brake levers on the hand grips. One representative of the mobile walker genus is described in detail in the U.S. Pat. No. 6,378,883 B1.

### SUMMARY OF THE INVENTION

It is the object of the invention to specify a mobile walker, a monitoring and information system and a method for operating a mobile walker, which assists the mobility-impaired person on a daily basis in an improved manner compared with known embodiments.

According to the invention, the set object is achieved with the mobile walker, the monitoring and information system and the method for operating a mobile walker according to the independent claims. Advantageous developments are specified in the dependent claims.

In accordance with the invention, a mobile walker, for instance a walking frame, is equipped with sensors for monitoring vital parameters and is connected to a separated intelligent system for assessing and monitoring the vital parameters. Vital parameters are measured values which reflect basic functions of the human body (=vital functions). The sensory measurement of the vital parameters contains for instance heart frequency, blood pressure, blood oxygen content, blood sugar content and the ability of the user of the mobile walker to respond and move.

The invention claims a mobile walker with a frame, having at least two wheels, which are arranged on the frame, in order to move the mobile walker around over a ground surface, and having at least one hand grip, which is arranged on the frame such that it can be used by a user of the mobile walker as a support and pushing aid. Furthermore, the walker has:
a) at least one measured value recording unit, which records at least one vital parameter of the user, and
b) a processor unit which is connected communicatively to the measured value recording unit and which assesses the recorded vital parameter and/or transmits the same to a control center arranged separately from the mobile walker.

The invention is advantageous in that physically disabled people can be easily monitored in respect of their vital parameters.

In one development the walker has at least one camera monitoring unit which is connected communicatively to the processor unit and which identifies and monitors the user, the facial expressions of the user and/or the movement of the user.

In one further embodiment the walker has at least one position recording unit which is connected communicatively to the processor unit and which determines the movements and motion dynamics of the mobile walker on the basis of features of the environment or the rotational movement of the wheels.

In a further embodiment, the walker has at least one geo-positioning system which is connected communicatively to the processor unit and which determines the current position of the mobile walker and if necessary indicates the same on a display (for instance in a digital map) or transmits the position to the control center.

In one development, the walker has at least one navigation system, which indicates to the user his/her position on a digital map and/or guides the user to a selectable destination.

In a preferred embodiment, the processor unit has at least one WLAN module and/or a mobile radio module for radio communication with the control center.

In one development the processor unit can automatically make an emergency call to the control center if the user is experiencing a medical emergency and/or is in a hazardous situation.

In a further embodiment, the walker has a video and speech communication unit which is connected communicatively to the processor unit and which establishes a video communication and speech communication between the user and an operator of the control center using the control center.

In one development of the invention at least one of the wheels can be driven by a motor.

In a further embodiment, at least one force sensor is arranged in the hand grip, which assists a user with a walking movement by servomotor. The force of the user introduced into the force sensor is converted in order to control the driven wheel.

The invention also claims a monitoring and information system having at least one inventive mobile walker and having at least one control center, which establishes a communicative connection with the mobile walker. For this purpose the control center may have a computing and control unit.

Moreover, the invention claims a method for operating an inventive mobile walker having the steps:
a) transmitting the vital parameter to the control center,
b) assessing the vital parameter in the control center and
c) transmitting instructions to the mobile walker as a function of the assessment.

Furthermore, the invention claims a method for operating an inventive mobile walker having the steps:
a) assessing the vital parameter in the processor unit, and
b) transmitting information to the control center as a function of the assessment.

In one development the method has the following additional steps:
a) transmitting movement data from the mobile walker to the control center, and
b) assessing the movement profile of the mobile walker in the control center.

The mobile walker improves the independent mobility of people with handicaps and increases safety against accidents and in emergency situations. An assistant may not be needed (cost reduction). The walker can be used as a training device for rehab patients and monitors the training success. The training/rehabilitation success can be significantly increased by adjusted and continuous training programs and by the independent performance and efficiency control by the patient. The navigation and position reduce the risk of people wandering and getting lost. They can be located in case of emergencies. Normally the navigation system can guide the user to the desired destination.

Other features which are considered as characteristic for the invention are set forth in the appended claims.

Although the invention is illustrated and described herein as embodied in a mobile walker, a monitoring and information system with a mobile walker and a method for operating a mobile walker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a mobile walker according to the invention; and

FIG. 2 is a block diagram of a monitoring and information system and the mobile walker.

### DETAILED DESCRIPTION OF THE INVENTION

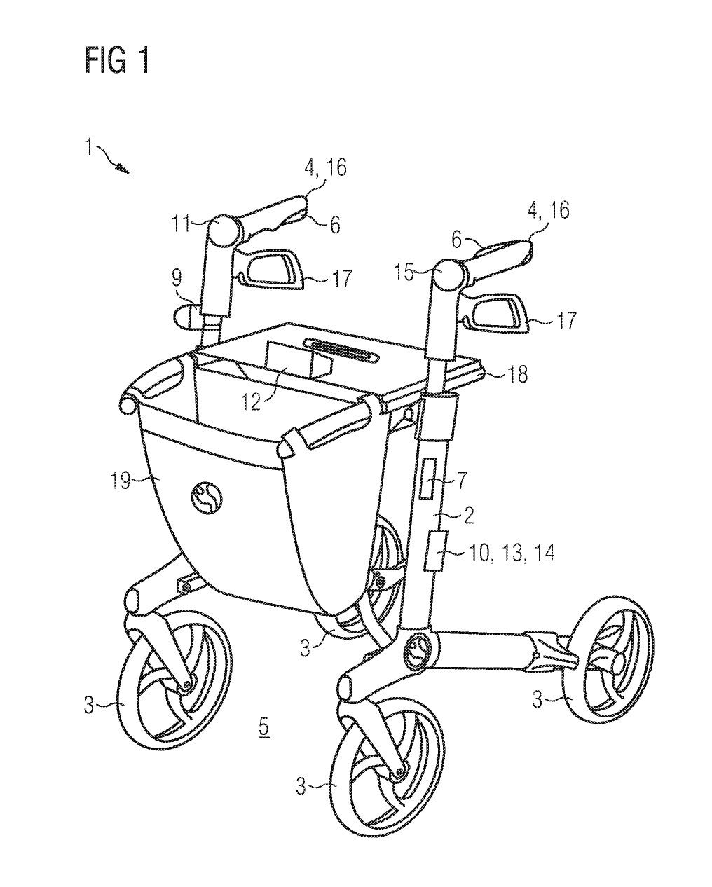

Referring now to the figures of the drawings in detail and first, particularly to FIG. 1 thereof, there is shown an inventive walker, for instance a walking frame or a Zimmer frame, may have the following functional units inter alia in addition to modules for monitoring vital parameters and their forwarding to a center (=control center).

A camera system identifies a person using the walker, identifies and monitors the facial expressions and the emotional state of the user, identifies and monitors the movements of the user and records the movement sequences and the motion dynamics of the user as a basis for identifying mobility and for training the user.

Position sensors are used to record and monitor the movements and the motion dynamics of the walker, wherein the position sensors are geared to environmental features and/or record the rotation of the wheels of the walker.

The walker has one or a number of positioning systems. In case of emergency or on request, the position recorded by the positioning system can be transmitted by the user to a control center. Global positioning systems such as e.g. GPS, Galileo or mobile radio can be used for positioning purposes. Alternatively, local positioning systems, such as e.g. radio-based systems WLAN, Bluetooth or optical systems, which are geared to visual features or 3D contours of the environment, can also be used.

The walker may have a navigation system, which affords the user an improved orientation and provides safety due to its knowledge of a place. Therefore older or disabled people can also be independently mobile without requiring assistance or do the shopping without running into danger or getting lost in a less well-known environment and no longer finding his/her way back home.

Corresponding guidance and travel information is presented visually by illustrations or symbols, by means of acoustic signals or speech and by means of tactile feedback as vibrations, deformations or e.g. by direction-dependent modulation of the movement resistance of the wheels and if applicable a drive system.

The communication with a control center or emergency call center is carried out by way of a fail-safe and manipulation-safe wireless transmission, such as e.g. by way of mobile radio or WLAN.

In case of emergencies a control center can be automatically informed by the vital parameters recorded with sensors and in particular by information for navigation or position determination combined with a module with artificial intelligence.

A critical situation of the user with an automatically triggered emergency call to a control center can be automatically identified e.g. from the response and/or the movement and motion dynamics (e.g. person has collapsed) or when leaving safe routes and areas.

Communication with the control center or a caregiver is carried out according to requirements by bidirectional speech and video communication and by transmitting relevant sensor and control information.

The user of the mobile walker also has, if necessary, the option, at the touch of a button, to send an emergency call directly to a control center by speech and/or video communication.

In the field of rehabilitation the mobile walker can be used as a training device. In such cases, it is possible for instance to count steps and to record and assess movement sequences, speed, routes or inclinations. Additional sensor information such as e.g. cameras and sensors for recording the wheel speed can be used for this purpose.

The user of the mobile walker can be encouraged and assisted to complete a predetermined or adaptive training program by means of visual, acoustic or tactile signals.

The use of driven and controlled wheels enables the mobile walker to encourage a rehab patient to move more quickly for instance or assist the patient when managing an inclination. The motor-driven assistance is activated by the user of the mobile walker by way of a release control element or an automatic adaptation to the movement and mobility of the user can take place.

The force and speed of the motor-driven assistance can be automatically adjusted according to the specifications of a training program, according to the current situation and according to the wishes of the user (e.g. with the aid of a special control element with a single-stage, multi-stage or continuous signal).

The steering of the mobile walker can be assisted by a motor, by force sensors in the handles (=hand grips) recording the desired speed and direction of movement.

The mobile walker can also carry out a route planning by the integrated navigation system and hence enable a derived, drive-assisted guidance of the user to the desired destination.

Seating integrated in the mobile walker extends the function of the walker, if necessary, to a motorized wheel-chair.

Movement sequences of the user of the mobile walker are recorded and analyzed by a 3D image recording (stereoscopy, time-of-flight camera etc.). Control of the motor-driven assistance is also derived herefrom. The analysis of the movement sequences during use can be made available to the nursing staff or therapist for instance.

An automated movement of the mobile walker that is not in use can also take place by way of a remote-controlled release of the drive function, so that a mobile walker can be sent for by a control center from a depot (for instance a charging station) to the site of operation or the walker can be piloted to a user. The movement can be carried out completely autonomously (with a set target) or also partially autonomously.

FIG. 1 shows an exemplary embodiment of an inventive mobile walker 1. The walker 1 has four wheels 3, which are arranged on the underside of a frame 2. The walker 1 can be rolled over a ground surface 5 using the wheels 3. At least two of the wheels 3 are rotatably mounted about a vertical axis in order to easily steer the walker 1. The upper end of the frame 2 of the walker 1 has two hand grips 4, with which the walker 1 can be pushed and against which a user of the walker 1 is able to support him/herself. The rear wheels 3 can be braked and locked with the aid of two lockable brake levers 17.

The walker 1 also has seating 18, on which the user can sit or for instance a tray can be placed. A transport pocket 19 fastened to the frame 2 completes the walker 1. The mobile walker 1 equipped in this way is often referred to as a walking frame or Zimmer frame.

The hand grips 4 are equipped with a measured value recording unit 6 in order to monitor vital parameters of the user of the walker 1, such as, for instance, pulse frequency and blood oxygen concentration. In such cases the oxygen concentration or the pulse frequency is recorded using sensors from the prior art. Further vital parameters, such as for instance the blood pressure or the electrical discharges of the heart or the brain can be recorded by sensors connected by cable or via radio.

The measured value recording unit 6 is connected communicatively to a processor unit 7 in a wired or wireless manner, which prepares the recorded vital parameters so that they can be transmitted via radio to a separate control center (for instance in the care home or in the hospital).

A camera monitoring unit 9 which is connected communicatively to the processor unit 7 is also attached to the frame 2. The general state of the user (for instance the facial expressions) and/or the movement of the user (for instance during a rehabilitation measure) can be recorded and monitored with the camera monitoring unit 9.

A position monitoring unit 10 is also attached to the frame 2 and connected communicatively to the processor unit 7. The position monitoring unit 10 can record the environment or a rotational movement of the wheels 3 using sensors and as a result determine and monitor the movement or motion dynamics of the walker 1 and thus of the user.

A geo-positioning system 11 which is connected communicatively to the processor unit 7 is also attached to the frame 2. The current position of the mobile walker 1 can be determined by way of satellite navigation for instance and if necessary transmitted to the control center 8.

Furthermore, the walker 1 has a navigation system 12, which can indicate to the user of the walker 1 in an acoustic and/or optical manner the route to the locations to be reached.

The processor unit 7 has a mobile radio module 13 and/or a WLAN module 14, with the aid of which it is possible to communicate with the control center 8 by way of radio.

The processor unit 7 is embodied and programmed such that an emergency situation of the user can be identified from the recorded data. In this case an emergency call or a distress call can be made automatically to the control center 8. An emergency situation can be identified for instance by monitoring the facial expressions or the vital parameters. If limit values are exceeded, the alarm can be raised. At the same time the position of the walker 1 can also be communicated to the control center 8.

A video and speech communication unit 15 that is connected communicatively to the processor unit 7 can also be mounted on the frame 2. The user can communicate with the control center 8 acoustically and optically by the video and speech communication unit 15.

The wheels 3 can also be motor-driven, for this purpose electric motors which are not visible are provided in the hub of the wheels 3 which are driven by a battery (not shown).

Force sensors 16 which record the pressure of the user and as a function thereof control the motor-driven wheels 3 (=servomotor assistance) can be integrated in the hand grips.

Alternatively or in addition the assessment of the vital parameters can take place in the processor unit 7 and the result can be indicated in situ or transmitted to the control center 8.

The functions and modules or units described in FIG. 1 can also be integrated in a motor-driven wheelchair.

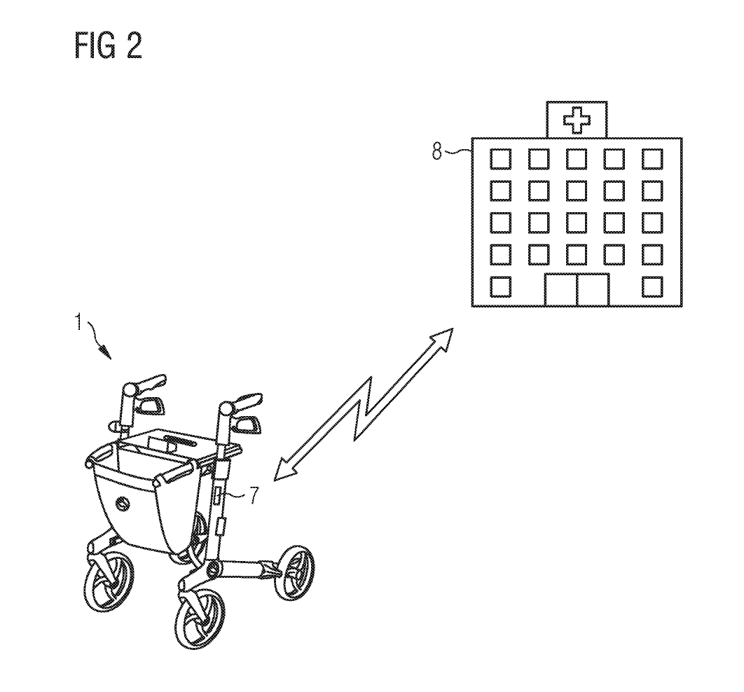

FIG. 2 shows a block diagram of a monitoring and information system with a mobile walker 1 according to FIG. 1. The walker 1 is connected by way of the processor unit 7 via radio to the control center 8. The vital parameters of the user of the walker 1 or position data of the walker 1 are transmitted to the control center 8 by way of this connection for instance. For this purpose the control center 8 has at least a processor and a memory.

Although the invention was illustrated and described in more detail by the exemplary embodiments, the invention is not restricted by the disclosed examples and other variations can be derived therefrom by the person skilled in the art without departing from the protective scope of the invention.

The following is a summary list of reference numerals and the corresponding structure used in the above description of the invention:
1 mobile walker
2 frame
3 wheel
4 hand grip
5 ground surface
6 measured value recording unit
7 processor unit
8 control center
9 camera monitoring unit
10 position recording unit
11 geo-positioning system
12 navigation system
13 mobile radio module
14 WLAN module
15 video and speech communication unit
16 force sensor
17 brake lever
18 seating
19 transport pocket

1. A mobile walker, comprising:
a frame;
at least two wheels embodied and disposed on said frame to move the mobile walker around on a ground surface;
at least one hand grip embodied and disposed on said frame to be used by a user of the mobile walker as a support and pushing aid;
at least one measured value recording unit embodied and programmed to record at least one vital parameter of the user; and
a processor unit connected communicatively to said measured value recording unit and embodied and programmed to assess a recorded vital parameter and/or transmit the recorded vital parameter to a control center disposed separately from the mobile walker.

2. The mobile walker according to claim 1, further comprising at least one camera monitoring unit connected communicatively to said processor unit and embodied and programmed to identify and monitor the user, facial expressions of the user and/or a movement of the user.

3. The mobile walker according to claim 1, further comprising at least one position recording unit connected communicatively to said processor unit and embodied and programmed to determine a movement and motion dynamics of the mobile walker on a basis of features of an environment or a rotational movement of said wheels.

4. The mobile walker according to claim 1, further comprising at least one geo-positioning system connected communicatively to said processor unit and embodied and programmed to determine a current position of the mobile walker and if necessary to indicate the current position and transfer the current position to the control center.

5. The mobile walker according to claim 1, further comprising at least one navigation system embodied and programmed to indicate a position on a digital map to the user and/or to guide the user to a selectable destination.

6. The mobile walker according to claim 1, wherein said processor unit has at least one of a WLAN module or a mobile radio module for radio communication with the control center.

7. The mobile walker according to claim 1, wherein said processor unit is embodied and programmed to automatically make an emergency call to the control center if the user is experiencing a medical emergency and/or is in a hazardous situation.

8. The mobile walker according to claim 1, further comprising a video and speech communication unit connected communicatively to said processor unit and embodied and programmed to establish video and speech communication between the user and an operator of the control center using the control center.

9. The mobile walker according to claim 1, wherein at least one of said wheels can be motor-driven.

10. The mobile walker according to claim 9, further comprising:
at least one servomotor; and
at least one force sensor disposed in said hand grip and embodied to assist a movement of the user by said servomotor for at least one of said wheels being a motor-driveable wheel.

11. A monitoring and information system, comprising:
at least one mobile walker containing a frame, at least two wheels embodied and disposed on said frame to move said mobile walker around on a ground surface, at least one hand grip embodied and disposed on said frame to be used by a user of said mobile walker as a support and pushing aid, at least one measured value recording unit embodied and programmed to record at least one vital parameter of the user, and a processor unit connected communicatively to said measured value recording unit and embodied and programmed to assess a recorded vital parameter; and
at least one control center embodied and programmed to establish a communicative connection with said mobile walker for receiving the recorded vital parameter.

12. A method for operating a mobile walker, which further comprises:
transmitting a vital parameter from the mobile walker to the control center;
assessing the vital parameter in the control center; and
transmitting information to the mobile walker in dependence on an assessment.

13. The method for operating a mobile walker, which comprises the steps of:
assessing a vital parameter in a processor unit of the mobile walker; and
transmitting information from the mobile walker to a control center in dependence on an assessment.

14. The method according to claim 13, which further comprises:
transmitting motion data from the mobile walker to the control center; and
assessing a movement profile of the mobile walker in the control center.
